(19) United States
(12) Patent Application Publication
(10) Pub. No.: US 2010/0013176 A1
(43) Pub. Date: Jan. 21, 2010

(54) WHEEL SUSPENSION

(75) Inventors: Simon Aramah, Osnabruck (DE); Knut Heidsieck, Bunde (DE); Felix Haeusler, Osnabruck (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/517,399

(22) PCT Filed: Dec. 4, 2007
(86) PCT No.: PCT/DE07/02179

§ 371 Date: Jun. 3, 2009

(30) Foreign Application Priority Data
Dec. 15, 2006 (DE) 10 2006 059 778.8

(51) Int. Cl. B60G 3/26; B60G 7/00

(52) U.S. Cl. 280/5.521; 280/124.136

(57) ABSTRACT

A wheel suspension assembly with a two-part wheel carrier (2) that supports a vehicle wheel (1). A first part (3) of the wheel carrier (2) is articulated to a second part (4) of the wheel carrier (2). Pivoting links (5, 6, 7) connect the first part (3) of the wheel carrier (2) to the second part (4) of the wheel carrier (2) and provide camber and/or tracking adjustment of the vehicle wheel (1).

This application is a National Stage completion of PCT/DE2007/002179 filed Dec. 4, 2007, which claims priority from German patent application serial no. 10 2006 059 778.8 filed Dec. 15, 2006.

### DESCRIPTION

The invention concerns a wheel suspension.

### BACKGROUND OF THE INVENTION

For fulfilling the safety and comfort requirements of a motor vehicle, the wheel suspension is a vital structural unit. Accordingly, disturbing influences that act upon the wheel suspension must be optionally compensated. For example, the effect of lateral forces on the vehicle's wheels, as produced when driving round a curve or when the vehicle body rolls, is to change the inclination of a vehicle wheel relative to the road surface. The vehicle wheel camber produced thereby leads to a variation of the tire contact area, so the all-important grip of the vehicle wheel on the ground is diminished.

Previously known dual transverse control arm axles compensate for this camber tendency by controlled influencing of the wheel position, in that a negative camber in the opposite direction is produced, which can be done by varying the length and/or orientation of the transverse control arm. This, however, has disadvantages when the motor vehicle is driving straight ahead, namely if individual vehicle wheels bounce on one side only, as can happen for example when driving over uneven ground. Moreover, with such dual transverse control arm wheel suspensions undesired tire wear takes place and valuable lateral force potential of the tire is lost.

EP 1 070 609 B1 describes a wheel suspension designed as a dual transverse control arm axle. The special feature of this solution is that compensation means in the form of a steering rocker is used, which forms an articulated connection between the ends of an upper and a lower link arm on the vehicle body side. Both ends of the link arms are arranged on a common steering rocker. The opposite ends of these transverse arms, i.e. those on the wheel side, are each attached to a wheel carrier.

Another wheel suspension for a motor vehicle is known from U.S. Pat. No. 6,929,271 B2. This wheel suspension has stabilizers as compensation means for the correction of wheel positions such as the wheel camber, such that both a connection of two opposite wheels, i.e. the wheels on the two sides of the vehicle, and also a coupling of the front to the rear wheels is provided. In this solution, as compensation means dual-action piston-cylinder units integrated in the stabilizers are used, which, for example when driving round a curve, compensate for undesired wheel movements. The wheel suspension known from U.S. Pat. No. 6,929,271 B2 has a transverse control arm coupled to a wheel carrier that supports a wheel of the vehicle.

A common feature of these known solutions is that the forces acting on the vehicle wheels and the resulting displacement of the wheels is compensated for by coupling several vehicle wheels to one another, using suitable compensation means for this purpose.

DE 10 2006 006 513 A1 also describes a wheel suspension for a motor vehicle, in which at least a first and a second link arm are each articulated to a wheel carrier supporting a vehicle wheel. The wheel suspension comprises compensation means for the correction of wheel positions, such that each link arm has a compensation means or is connected to a compensation means and the compensation means of each vehicle wheel are connected to one another by at least one coupling element. This solution provides a force-regulated, passive camber adjustment of the vehicle wheels. Depending on the design layout, the tracking behavior of the vehicle wheel under the influence of a lateral force can also be regulated passively.

Moreover, from US 2005/0236797 A1 a wheel suspension is known, with a wheel carrier made in two pieces which supports a vehicle wheel, a first part of the wheel carrier being articulated to a second part of the wheel carrier. To connect the first part of the wheel carrier to the second part of the wheel carrier, compensation means of elaborate design are provided.

### SUMMARY OF THE INVENTION

The purpose of the present invention is to provide a wheel suspension for a motor vehicle, with which the camber and/or tracking adjustment of the individual vehicle wheels is made possible by simple means.

A wheel suspension with a wheel carrier made in two parts which supports a vehicle wheel, in which a first part of the wheel carrier is articulated to a second part of the wheel carrier, has been developed further to the effect that compensation means are used to connect the first part of the wheel carrier to the second part of the wheel carrier.

In this context compensation means are understood to be structural elements or structural groups which equalize, transmit or compensate movements.

In a certain sense this solution can be said to be a “force-regulated”, or better, “force-controlled” design, which means that a lateral force acting on the vehicle wheel changes the camber and/or the track of the vehicle wheel and, according to the invention, a compensation of the camber and/or track in the opposite direction to the change takes place.

With such a solution it is now also possible to apply the principle of passive camber and tracking adjustment not only to a limited number of vehicle suspensions, but to use it with all previously known wheel suspensions, the term “passive” being understood to mean that no “active” elements are used which influence the camber or track of the vehicle wheel by virtue of externally supplied energy. Here, the passive camber adjustment is integrated in the wheel carrier itself. According to the invention this consists of two parts. By dividing the wheel carrier into two individual components the parts of the wheel carrier can be moved relative to one another. Tracking and camber corrections can then be carried out in an optimum manner. Thanks to the invention the safety of a motor vehicle can be increased considerably. The wheel carriers according to the solution proposed here can be used for both steered and unsteered wheel suspensions.

Thanks to this arrangement it is also possible to produce an additional negative camber of the vehicle wheel relative to the superstructure (body) of the vehicle, which significantly increases the lateral force potential of the tire. Expressed differently, the grip between the road and the tire while driving round a curve is improved. The result of the invention is that the necessary component movements take place exclusively in the “wheel carrier system”, so the invention can be used with different axle systems. Besides the increased lateral force potential, tire wear can also be reduced in an advantageous way.

As compensation means, a pivoting link can be used, according to the invention the pivoting link is designed as a wishbone having at least three articulation points. By connecting the two wheel carrier parts via the compensation means they are indirectly coupled to one another. Wishbones have proved to work particularly well as compensation means because they have three articulations. Thus, not only is an indirect coupling of the two wheel carrier parts produced, but a further pivot point is available on each wishbone by means of which, according to the invention, the wishbones can be coupled to one another by a coupling element suitable for the purpose.

In a further development of the invention it is also proposed that the articulations can be ball joints, rotary joints or elastomeric mountings. Elastomeric mountings here are understood to be articulations with at least one elastomer layer. Such elastomeric mountings have the advantage that according to their structure they can produce a given restoring torque based on the elastic properties of the elastomer material. In the simplest case the elastomer layer can be a hinge joint with damping properties.

It is within the scope of the invention to have pivoting links of different sizes. The dimensions of the pivoting links can be chosen such that a lateral force occurring at the wheel contact point first produces a movement of the lower pivoting point of the first part of the wheel carrier, i.e. the part on the wheel side, in the direction of the lateral force. This movement is transmitted, via the pivoting link and at least one coupling element, to the upper pivoting point of the wheel carrier. To produce a negative camber during this, the upper pivoting point undergoes a larger movement in the direction of the lateral force.

For example, a first preferred geometrical design of the pivoting link can be such that on the side of a vehicle wheel, the distance between the vehicle-wheel-side, upper (relative to the motor vehicle) connection point and the lower connection point of an upper pivoting link is larger than the distance between the vehicle-wheel-side, upper connection points and the associated lower connection points of the other, i.e. the lower pivoting link.

Likewise, the ratio of the distance of the vehicle-wheel-side, upper (relative to the motor vehicle) connection point of an upper pivoting link, to the distance of the vehicle-body-side, upper connection point of the same, upper pivoting link, can be larger than the ratio of the distance of the vehicle-wheel-side, upper connection point to the distance of the vehicle-body-side, upper connection point of the other, lower pivoting link.

Of course, such design variants can also be used in combination with one another.

Below, the invention is explained in more detail with reference to the attached drawings. The example embodiments shown do not imply any restriction to the variants illustrated, but serve only to explain some principles of wheel suspensions according to the invention. In the figures, the same or similar components are given the same index numbers. To be able to clarify the functional modes according to the invention, the figures show only greatly simplified representations in principle, in which components not relevant to the invention are omitted. This, however, does not mean that such components are not present in a wheel suspension according to the invention.

### BRIEF DESCRIPTION OF THE DRAWINGS

The figures show:

FIG. 1: Simplified schematic illustration of a first embodiment of the invention, with reference to an undeflected vehicle wheel

FIG. 2: The wheel suspension of FIG. 1 with a deflected vehicle wheel

FIG. 3: Simplified schematic illustration of a second embodiment of a wheel suspension according to the invention, with reference to an undeflected vehicle wheel

FIG. 4: The wheel suspension of FIG. 3 with a deflected vehicle wheel, and

FIG. 5: Simplified schematic illustration of a third embodiment of a wheel suspension according to the invention, with a partial three-dimensional view of the wheel suspension

### DETAILED DESCRIPTION OF THE PREFERRED EMBODIMENTS

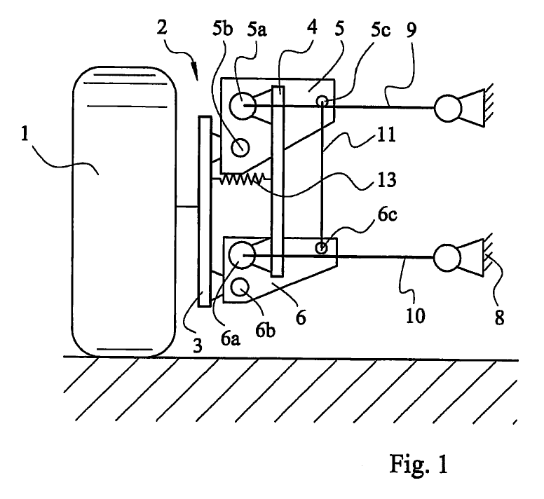

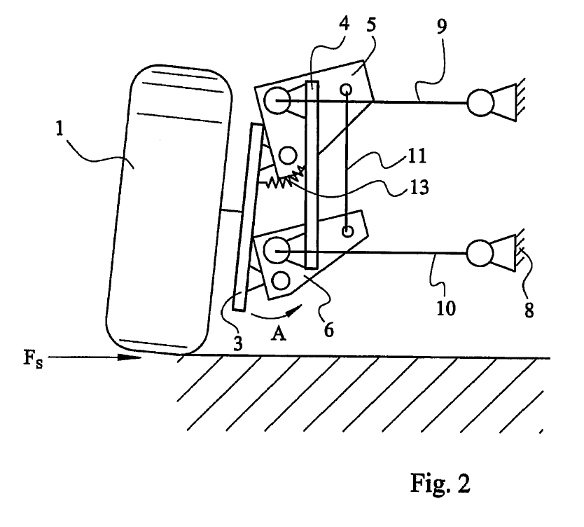

The first variant of a solution according to the invention, shown in FIGS. 1 and 2, comprises a vehicle wheel 1 mounted to rotate on a wheel carrier indexed, as a whole, as 2. The difference between the representation in FIGS. 1 and 2 is only that FIG. 1 shows a vehicle wheel 1 which is not deflected and FIG. 2 a vehicle wheel 1 which is deflected.

The wheel carrier 2 consists of a first part 3 with a second part 4 connected thereto. The connection between the parts 3 and 4 of the wheel carrier 2 is formed by two pivoting links 5 and 6 made as wishbones. The wishbones 5 and 6 have in each case three articulation points 5a, 5b, 5c or 6a, 6b, 6c. At least one of the articulation points 5a, 5b, 5c or 6a, 6b, 6c comprises an elastomeric mounting or consists entirely of such an elastomeric mounting.

The first part 3 of the wheel carrier 2 is connected by a respective articulation 5b, 6b to the wishbones 5 and 6. The second part 4 of the wheel carrier 2, in contrast, is connected to the wishbones 5 and 6 by the articulation points 5a, 6a. Further, the wishbones 5 and 6 are connected to one another via the articulation points 5c and 6c by a coupling element 11 made as a hinged link. Because of this hinged link 11 the wishbones 5 and 6 move in the same direction.

The wheel suspension for a motor vehicle shown can be used both for a steered vehicle wheel and for a non-steered wheel. In the case of a steered vehicle wheel the steering system would be attached to the second part 4 of the wheel carrier 2.

As can be seen from the representations in FIGS. 1 and 2, the wishbones 5 and 6 have different geometrics. Because of the different geometrical designs of the wishbones 5 and 6 the movement sequence between the parts 3 and 4 of the wheel carrier 2 that can move relative to one another can be controlled specifically. Thus, the wheel suspension shown in FIGS. 1 and 2 can be used for force-regulated or force-controlled, mechanical, passive camber adjustment.

To connect the wheel carrier 2 and hence the vehicle wheel 1 to the vehicle body 8, link arms 9 and 10 are used. These link arms 9 and 10, in the present case consisting of transverse control arms, are connected to the articulation points 5a and 6a respectively. If the vehicle wheel 1 is deflected, for example as the result of a lateral force Fs acting on it as shown in FIG. 2, the lower wishbone 6 swivels in the direction of the arrow A in FIG. 2. The pivoting movement of the wishbone 6 takes place around the articulation point 6b. By virtue of the coupling element 11 made as a pivoting link, this movement is transmitted to the upper wishbone 5 in accordance with the arrow A in FIG. 2, so that this too necessarily swivels around the articulation point 5b in the direction of the arrow A. As can be seen clearly from the representation in FIG. 2, in a deflected position of the vehicle wheel 1 the parts 3 and 4 of the wheel carrier 2 have different angular positions in space. This produces the desired additional negative camber when driving round a curve. Thanks to the consequently increased grip between the tire and the road, the safety of the vehicle is also increased.

To produce a restoring force the parts 3 and 4 of the wheel carrier 2 are coupled to one another by a spring 13. Here, the spring 13 represents only symbolically an element that enables the restoring force. Equivalent means such as spring-damper units or other components can likewise be used.

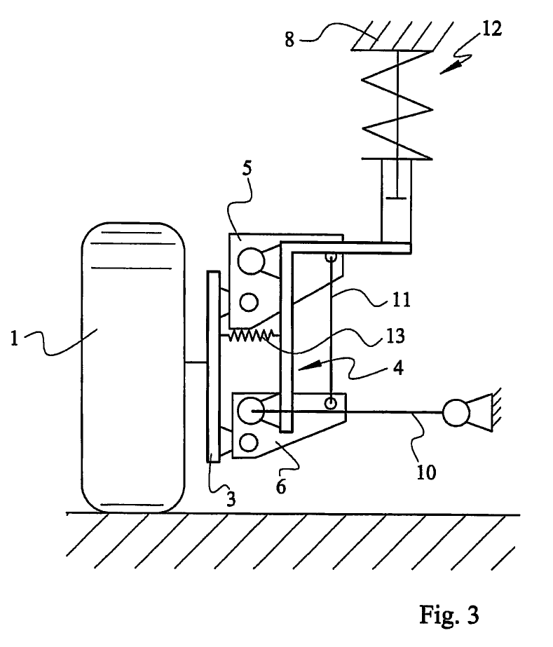

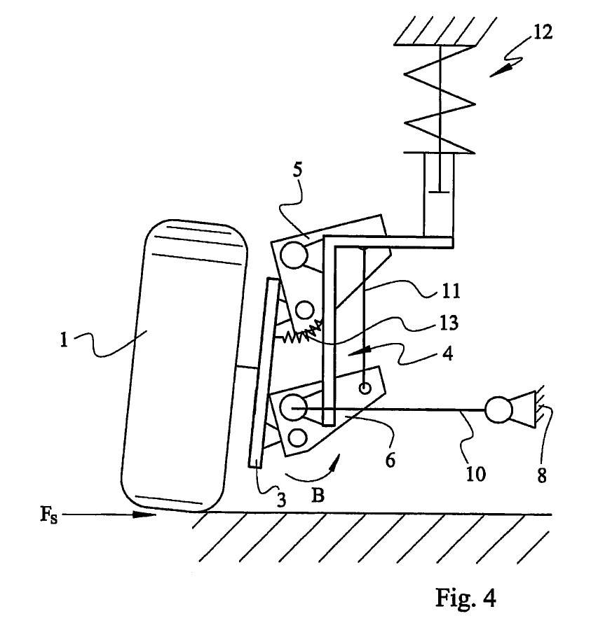

FIGS. 3 and 4 show another embodiment variant of the invention. In this case too the vehicle wheel 1 is held by a wheel carrier 2. As before, the wheel carrier 2 consists of two parts 3 and 4. The first part 3 of the wheel carrier 2 is connected at the articulation points 5b and 6b to respective wishbones 5 and 6. The articulation points 5a and 6a of the wishbones 5 and 6 form the link to the second part 4 of the wheel carrier 2 and the link arms 9 and 10. The link arms 9 and 10 are made as transverse control arms.

This variant of a wheel suspension, too, has a hinged link 11 as the coupling element which connects the articulation points 5c and 6c of the wishbones 5 and 6.

FIG. 3 shows a McPherson wheel suspension with a spring-damper unit 12 for a non-deflected vehicle wheel. In contrast to FIG. 3, FIG. 4 shows the otherwise identical wheel suspension from FIG. 3, this time with a deflected vehicle wheel. In this case a lateral force Fs acts on the vehicle wheel 1 so that the wheel is deflected. The vehicle wheel 1 tilts by a certain angle, and as a result the lower wishbone 6 swivels around the articulation point 6b in the direction of the arrow B in FIG. 4. Since the wishbones 5 and 6 are coupled via the hinged link 11, the movement undergone by the wishbone 6 is transmitted directly to the upper wishbone 5 above it. This swivels around the articulation point 5b, again in the direction of the arrow B in FIG. 4.

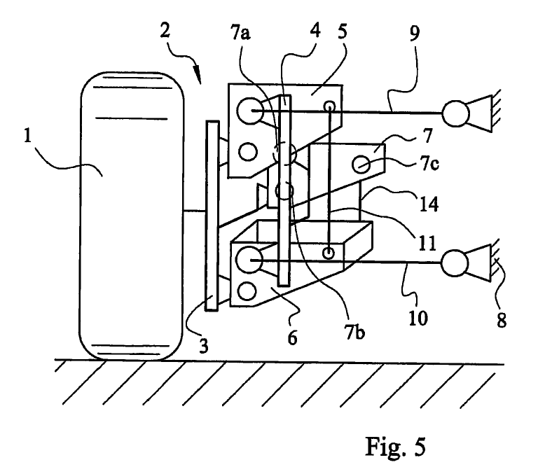

FIG. 5 shows another variant of a wheel suspension according to the present invention. With such a wheel suspension both the camber and the tracking can be adjusted passively. The adjustment takes place mechanically and in a force-regulated or force-controlled manner. For this purpose an additional wishbone 7 is provided.

As already explained in connection with the representations in FIGS. 1 and 2, this wheel suspension too comprises an upper wishbone 5 and a lower wishbone 6.

Two transverse control arms 9 and 10 connect the wishbones 5 and 6 respectively, starting from the articulation points 5a and 6a, to the vehicle body 8. The first part 3 of the wheel carrier 2 is connected at the articulation points 5b and 6b to respectively associated wishbones 5 and 6. The second part 4 of the wheel carrier 2 is connected to the articulation points 5a and 6a of the wishbones 5 and 6. Between the wishbones 5 and 6 is a coupling connection consisting of a hinged link 11. This is attached to the articulation points 5c and 6c of the wishbones 5 and 6. Thus far, the embodiment shown here in FIG. 5 is identical to the variant shown in FIGS. 1 and 2. The difference now consists in the additional wishbone 7, which also has three articulation points 7a, 7b and 7c. This is arranged laterally adjacent to but at a different height from the lower wishbone 6 and the upper wishbone 5. The articulation point 7a is coupled to the second part 4 of the wheel carrier 2. At the articulation point 7b, the third wishbone 7 is connected to the first part 3 of the wheel carrier 2. The articulation 7c serves for the connection of a coupling element 14, which in this wheel suspension consists of a hinged link whose opposite end is connected to the articulation point 6c of the lower wishbone 6. By virtue of the coupling of the wishbone 6 to the wishbone 5 and to the wishbone 7 by means of the respective hinged links 11 and 14, the wishbones 5 and 7 move synchronously when the wishbone 6 swivels around the articulation point 6b because of a deflection of the vehicle wheel 1. As already mentioned earlier, in this embodiment too at least one of the articulations is made as an elastomeric mounting or comprises an elastomeric mounting.

### LIST OF INDEXES

1 Vehicle wheel
2 Wheel carrier
3 First part of the wheel carrier
4 Second part of the wheel carrier
5 Compensation means (pivoting link)
6 Compensation means (pivoting link)
7 Compensation means (pivoting link)
8 Vehicle body
9 Link arm
10 Link arm
11 Coupling element (hinged link)
12 Spring—damper unit
13 Spring
14 Coupling element (hinged link)

1-7. (canceled)

8. A wheel suspension with a two-part wheel carrier (2) supporting a vehicle wheel (1),
a first part (3) of the wheel carrier (2) being articulated to a second part (4) of the wheel carrier (2),
vertically upper and vertically lower compensation means (5, 6, 7) being provided for connecting the first part (3) of the wheel carrier (2) to the second part (4) of the wheel carrier (2), and
at least one coupling element (11, 14) forming a connection between the upper and the lower compensation means (5, 6 or 7, 6).

9. The wheel suspension according to claim 8, wherein the upper and the lower compensation means (5, 6, 7) are each wishbones which have at least three articulations (a, b, c).

10. The wheel suspension according to claim 9, wherein the at least three articulations (a, b, c) are each one of a ball joint, a rotary joint and an elastomeric mounting.

11. The wheel suspension according to claim 8, wherein dimensions of the upper and the lower compensation means (5, 6, 7) are different from one another.

12. The wheel suspension according to claim 8, wherein a distance between a vehicle-wheel-side, vertically upper connection point (5a), relative to the motor vehicle, and a vertically lower connection point (5b) of the upper compensation means (5) is larger than a distance between vehicle-wheel-side, upper connection points (6a, 7a) and associated lower connection points (6b, 7b) of the lower compensation means (6, 7).

13. The wheel suspension according to claim 12, wherein a ratio of the distance of the vehicle-wheel-side, upper connection point (5a), relative to the motor vehicle, of the upper compensation means (5) to the distance of the vehicle-body-side, upper connection point (5c) of the upper compensation means (5), is larger than a ratio of the distance of the vehicle-wheel-side, upper connection points (6a, 7a) to the distance of the vehicle-body-side, upper connection points (6c, 7c) of the lower compensation means (6, 7).

14. The wheel suspension according to claim 8, wherein the first part and the second part (3, 4) of the wheel carrier (2) are connected to one another by a spring (13) which produces a restoring force.

15. A wheel suspension having a two-part wheel carrier (2) supporting a vehicle wheel (1),
a first part (3) of the wheel carrier (2) being articulated to a second part (4) of the wheel carrier (2),
vertically upper and vertically lower compensation links (5, 6, 7) being provided for connecting the first part (3) of the wheel carrier (2) to the second part (4) of the wheel carrier (2), and
at least one coupling element (11, 14) interconnecting the upper and the lower compensation links (5, 6 or 7, 6) with one another.

16. A suspension assembly for a wheel (1) of a vehicle, the assembly comprising:
first and second wheel carrier parts (3, 4) rotatably support the vehicle wheel (1);
upper and lower wishbones (5, 6) each comprising first, second and third articulation points (5a, 5b, 5c, 6a, 6b, 6c), the first wheel carrier part (3) being pivotally coupled to the upper wishbone (5) by the second articulation point (5b) of the upper wishbone (5) and pivotally coupled to the lower wishbone (6) by the second articulation point (6b) of the lower wishbone (6) and the second wheel carrier part (4) being pivotally coupled to the upper wishbone (5) by the first articulation point (5a) of the upper wishbone (5) and pivotally coupled to the lower wishbone (6) by the second articulation point (6a) of the lower wishbone (6);
one end of a coupling element (11) is pivotally coupled to the upper wishbone (5) by the third articulation point (5b) of the upper wishbone (5) and an opposed end of the coupling element (11) being pivotally coupled to the lower wishbone (6) by the third articulation point (6b) of the lower wishbone (6);
the first articulation point (6a) of the lower wishbone (6) being fixed to a body (8) of the vehicle by a lower linkage arm (10) and the first articulation point (5a) of the upper wishbone (5) being coupled to the body (8) of the vehicle by a suspension support unit (9, 12); and
a spring (13) being coupled to the first and the second wheel carrier parts (3, 4) and applying a restoring force thereon as the first and the second wheel carrier parts (3, 4) and the upper and the lower wishbones (5, 6) pivot with respect to each other.
